(19) United States
(12) Patent Application Publication
(10) Pub. No.: US 2015/0297924 A1
(43) Pub. Date: Oct. 22, 2015

(54) SPRINKLER SYSTEM INCLUDING A MIXING DEVICE UPSTREAM OF A SPRINKLER

(71) Applicants: May L. Corn, Manchester, CT (US); Guido Poncia, Glastonbury, CT (US); Enrico Manes, Feeding Hills, MA (US); Jeffrey M. Cohen, Hebron, CT (US); Michael R. Carey, East Hampton, CT (US); Joshua A. Sheffel, Manchester, CT (US)

(72) Inventors: May L. Corn, Manchester, CT (US); Guido Poncia, Glastonbury, CT (US); Enrico Manes, Feeding Hills, MA (US); Jeffrey M. Cohen, Hebron, CT (US); Michael R. Carey, East Hampton, CT (US); Joshua A. Sheffel, Manchester, CT (US)

(73) Assignee: UTC Fire & Security Corporation, Farmington, CT (US)

(21) Appl. No.: 14/351,206

(22) PCT Filed: Oct. 14, 2011
(86) PCT No.: PCT/US11/56271

§ 371 Date: Apr. 11, 2014

(51) Int. Cl. A62C 5/00; A62C 35/68; B05B 7/04

(52) U.S. Cl. CPC A62C 5/008; B05B 7/0483; A62C 35/68

(57) ABSTRACT

An exemplary sprinkler system includes a liquid supply conduit and a gas supply conduit. A mixing device is coupled to the liquid supply conduit and the gas supply conduit. The mixing device is configured to establish a mixture of liquid from the liquid supply conduit and gas from the gas supply conduit. The mixture has a selected gas-to-liquid ratio. A sprinkler supply conduit is coupled with the mixing device for carrying the mixture downstream from the mixing device. A sprinkler coupled with the sprinkler supply conduit is configured to receive the mixture and to discharge a fire suppression mist.

### BACKGROUND

There are a variety of fire suppression sprinkler systems. Different systems provide different types of fire suppression discharge. Some systems release large amounts of water into an area and are referred to as deluge systems. Others include sprinklers for spraying water. Some systems introduce a water mist into an area for fire suppression purposes.

Water mist systems typically require a supply of liquid such as water. Many such systems utilize high liquid pressures to atomize liquid and achieve a fine mist. The required pressures for such systems render the pump and appropriately pressure-rated piping relatively expensive. The necessary materials such as the pump or other source of pressure and high pressure-rated piping associated with such systems can render them undesirable or impractical in some situations. Alternative arrangements would be useful.

### SUMMARY

An exemplary sprinkler system includes a liquid supply conduit and a gas supply conduit. A mixing device is coupled to the liquid supply conduit and the gas supply conduit. The mixing device is configured to establish a mixture of liquid from the liquid supply conduit and gas from the gas supply conduit. The mixture has a selected gas-to-liquid ratio. A sprinkler supply conduit is coupled with the mixing device for carrying the mixture downstream from the mixing device. A sprinkler coupled with the sprinkler supply conduit is configured to receive the mixture and to discharge a fire suppression mist.

The various features and advantages of a disclosed example will become apparent to those skilled in the art from the following detailed description. The drawing that accompanies the detailed description can be described as follows.

### BRIEF DESCRIPTION OF THE DRAWINGS

FIG. 1 schematically shows a sprinkler system desired according to an embodiment of this invention.

### DETAILED DESCRIPTION

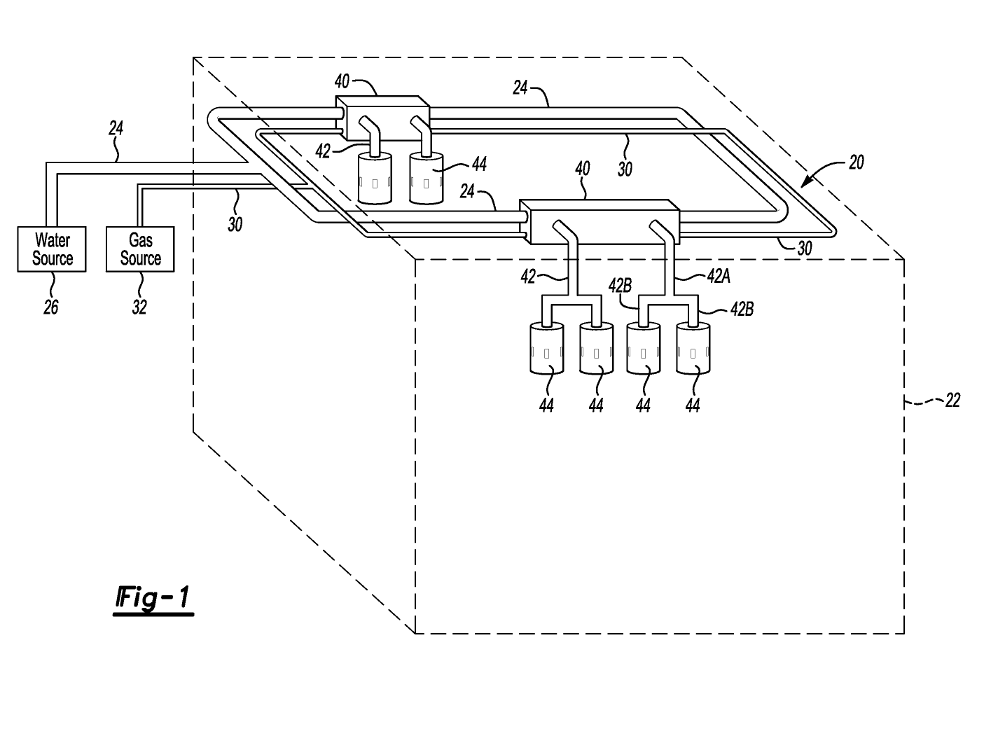

FIG. 1 schematically shows a sprinkler system 20 arranged to provide fire suppression in at least selected portions of a building 22. A liquid supply conduit 24 is configured to carry liquid from a source 26 into the building 22. In one example, the liquid comprises water and the water source 26 is a municipal water supply or a well, for example. The liquid supply conduit 24 in one example comprises metal pipes such as galvanized or copper tubing.

A gas supply conduit 30 is configured to carry gas from a gas source 32 into the building 22. In one example, the gas comprises air and the gas source 32 comprises a pump or a compressor, for example.

A plurality of mixing devices 40 are situated within the building 22. Each mixing device 40 is coupled to the liquid supply conduit 24 and the gas supply conduit 30. Each mixing device 40 establishes a mixture of the liquid from the liquid supply conduit 24 and the gas from the gas supply conduit 30. The mixture established by the mixing device 40 has a selected gas-to-liquid ratio. In one example, the gas-to-liquid ratio is within a range that establishes a bubbly mixture of air and water, for example.

Sprinkler supply conduits 42 extend from the mixing devices 40. Sprinklers 44 are coupled to the sprinkler supply conduits 42. Each sprinkler supply conduit 42 carries the mixture from the associated mixing device 40 to any sprinkler 44 coupled with that sprinkler supply conduit 42. The sprinklers 44 are configured to receive the mixture and to discharge a fire suppression mist.

The sprinklers 44 are dual fluid sprinklers that utilize two fluids (e.g., a liquid such as water and a gas such as air) for achieving a desired fire suppression discharge. In one example, the sprinklers 44 comprise effervescent sprinkler nozzles. Effervescent atomization can be achieved using relatively low water and air pressures, which reduces the complexity and expense associated with supplying liquid and gas to the sprinkler system 20.

Utilizing mixing devices 40 downstream of the liquid source 26 and gas source 32 and upstream of the sprinklers 44 allows for avoiding having the liquid supply conduit 24 and gas supply conduit 30 network extending to each of the sprinklers 44 for delivering the liquid and gas (e.g., water and air) to each sprinkler 44. Instead, the mixing devices 40 can be coupled to those conduits and then have single sprinkler supply conduits 42 extending to the location of each sprinkler 44. The illustrated example allows for realizing some of the advantages of a “single-pipe” system used for distributing a liquid and gas mixture to a misting sprinkler nozzle without experiencing the drawbacks that can be associated with single-pipe systems. For example, it is technically challenging to distribute a mixture flow from a single source to a plurality of sprinklers in various locations throughout a building. Extending conduit lengths make it difficult to maintain flows with desired gas-to-liquid ratios throughout such a network of conduits. Additionally, as a mixture flows across pipe fitting junctions, that introduces challenges for maintaining desired gas-to-liquid ratios. Attempting to realize a single-pipe system throughout a building can require relatively higher pressure compressors, pumps and other components that compensate for additional pressure drops as the mixture flows through relatively long pipes for distribution throughout a building.

At the same time, the illustrated example allows for having relatively short individual pipes supplying each sprinkler head or a set of sprinklers, which reduces the cost of having to provide two pipes (i.e., one for gas and one for liquid) to each sprinkler. Additionally, the illustrated example allows for using relatively lower cost sprinkler nozzles because there is no requirement for relatively complicated mixing components at the sprinkler for mixing the gas and liquid within the nozzle. Instead, with the illustrated example mixing devices 40 each sprinkler is already supplied with a mixture having a desired gas-to-liquid ratio. The sprinkler supply conduits 42 have a much shorter length on average than the supply conduits 24 and 30. Additionally, the mixing deices 40 can be strategically positioned to avoid turns along the fluid path between the mixing device and the associated sprinklers.

Each of the mixing devices 40 in the illustrated example are downstream from the sources 26 and 32 and upstream of the sprinklers 44. One of the mixing devices 40 has each sprinkler supply conduit 42 associated with a single sprinkler 44. The other example mixing device 40 has a plurality of sprinklers coupled to each sprinkler supply conduit 42. A first portion 42A has a first end near the mixing device and a second end distal from the mixing device 40. Second portions 42B extend between the second end of the first portion 42A and the sprinklers 44. In other words, the illustrated example includes some sprinkler supply conduits 42 that carry the mixture directly from the mixing device 40 to a single sprinkler 44. Other sprinkler supply conduits 42 include branches that carry the mixture from the associated mixing device 40 to a plurality of sprinklers 44.

The illustrated example allows for arranging a sprinkler system so that it is partially like a single-pipe supply system and partially like a dual-pipe supply system to realize the advantages of both and to avoid the drawbacks of both.

The preceding description is exemplary rather than limiting in nature. Variations and modifications to the disclosed example may become apparent to those skilled in the art that do not necessarily depart from the essence of this invention. The scope of legal protection provided to this invention can only be determined by studying the following claims.

We claim:

1. A sprinkler system, comprising:
a liquid supply conduit;
a gas supply conduit;
a mixing device coupled to the liquid supply conduit and the gas supply conduit, the mixing device being configured to establish a mixture of liquid from the liquid supply conduit and gas from the gas supply conduit, the mixture having a selected gas-to-liquid ratio;
a sprinkler supply conduit coupled with the mixing device for carrying the mixture downstream from the mixing device; and
a sprinkler coupled with the sprinkler supply conduit, the sprinkler being configured to receive the mixture and to discharge a fire suppression mist.

2. The sprinkler system of claim 1, wherein the liquid comprises water.

3. The sprinkler system of claim 1, wherein the gas comprises air.

4. The sprinkler system of claim 1, wherein the sprinkler comprises a dual fluid sprinkler.

5. The sprinkler system of claim 4, wherein the sprinkler comprises an effervescent sprinkler nozzle.

6. The sprinkler system of claim 1, comprising a plurality of sprinklers coupled with the sprinkler supply conduit.

7. The sprinkler system of claim 6, wherein the sprinkler supply conduit comprises
a first portion having one end near the mixing device and a second end distal from the mixing device; and
a plurality of second portions having one end near the second end of the first portion and another end coupled to one of the sprinklers.

8. The sprinkler system of claim 1, wherein the liquid supply conduit has a first length and the sprinkler supply conduit has a second, shorter length.

9. The sprinkler system of claim 1, wherein
the sprinkler is positioned within a building;
the liquid supply conduit is within the building and coupled with a liquid source outside of the building; and
the mixing device is within the building downstream of the liquid source and upstream of the sprinkler.

10. The sprinkler system of claim 1, comprising
a plurality of sprinkler supply conduits coupled with the mixing device; and
at least one sprinkler coupled with each sprinkler supply conduit.
